(19) United States
(12) Patent Application Publication
(10) Pub. No.: US 2025/0182677 A1
(43) Pub. Date: Jun. 5, 2025

(54) DISPLAY DEVICE

(71) Applicant: LG Display Co., Ltd., Seoul (KR)

(72) Inventor: Daekyu KIM, Paju-si (KR)

(21) Appl. No.: 18/774,648

(22) Filed: Jul. 16, 2024

(30) Foreign Application Priority Data
Nov. 30, 2023 (KR) 10-2023-0170641

(51) Int. Cl. G09G 3/32

(52) U.S. Cl. CPC G09G 3/32; G09G 2310/0267; G09G 2320/0233; G09G 2320/0247; G09G 2330/021

(57) ABSTRACT

A display device includes a gate driver for applying a scan signal, an emission signal, and an inverted emission signal to the pixel circuits, in which the gate driver includes at least one scan driver for outputting the scan signal. The device includes a light emitting driver for outputting the emission signal, and inverting drivers of which at least some output an inverted emission signal of which phase is inverted from that of the emission signal using the scan signal output from the at least one scan driver and the emission signal output from the light emitting driver. Accordingly, the charging delay of the light emitting element upon the low-frequency driving in the variable refresh rate mode can be prevented and the characteristics and on-bias stress of the driving transistor can be adjusted.

### CROSS REFERENCE TO RELATED APPLICATION

The present application claims priority to Korean Patent Application No. 10-2023-0170641, filed Nov. 30, 2023, the entire contents of which is incorporated herein for all purposes by this reference.

### BACKGROUND

### Technical Field

The present specification relates to a display device for preventing charging delay of a light emitting element upon low-frequency driving in a variable refresh rate mode and improving the characteristics and on-bias stress of a driving transistor.

### Description of the Related Art

As the information society develops, various demands for display devices for displaying images are increasing, and various types of display devices such as liquid crystal display (LCD) devices and organic light emitting diode (OLED) display devices are utilized.

Images displayed on a display device may be still images or moving images, and the moving image may include various types such as sports images, game images, and movies. The display device is driven in a variable refresh rate (VRR) mode in which a driving frequency varies depending on the type of an image, thereby reducing power consumption and extending the lifetime of the display device.

### BRIEF SUMMARY

The inventors of the present specification have appreciated that when the variable refresh rate mode is applied to drive pixels at various refresh rates, a brightness difference occurs between the pixels due to different refresh rates, thereby causing quality degradation, such as image warpage or flicker. The various embodiments of the present specification adress the various technical problems in the related art, including the above-identified problem.

For example, some embodiments of the present specification is directed to providing a display device, which includes a transistor configured to have a gate electrode receiving an inverted emission signal, thereby improving charging/discharging delay of a light emitting element and forms a capacitor between an inverted emission line and a node of a pixel, thereby reducing on-bias stress of a driving transistor.

A display device according to an embodiment of the present specification includes a display panel including a display area in which pixel circuits are disposed and a non-display area near the display arca, and a gate driver configured to apply a scan signal, an emission signal, and an inverted emission signal to the pixel circuit, wherein the gate driver includes at least one scan driver configured to output the scan signal, a light emitting driver configured to output the emission signal, and inverting drivers of which at least some output the inverted emission signal of which phase is inverted from that of the emission signal using the scan signal output from the at least one scan driver and the emission signal output from the light emitting driver.

The technical benefits of the present specification are not limited to the above-described benefits, and other benefits that are not mentioned will be able to be clearly understood by those skilled in the art from the following description.

### BRIEF DESCRIPTION OF THE SEVERAL VIEWS OF THE DRAWINGS

FIG. 1 is a block diagram schematically showing a display device according to one embodiment of the present specification.

FIG. 2 is a method of driving the display device according to related art.

FIG. 3 is a view showing a method of driving a display device according to an embodiment of the present specification.

FIG. 4 is a block diagram showing a configuration of a gate driver in the display device according to one embodiment of the present specification.

FIGS. 5A to 5D are circuit diagrams of pixels according to a first embodiment.

FIG. 6 is a view showing a method of driving the pixels shown in FIGS. 5A to 5D.

FIG. 7 is a block diagram showing a configuration of a scan driver in the display device according to one embodiment of the present specification.

FIG. 8 is a block diagram showing a configuration of a light emitting driver in the display device according to one embodiment of the present specification.

FIG. 9 is a block diagram showing a configuration of an inverted gate driver in the display device according to one embodiment of the present specification.

FIG. 10 is a cross-sectional view showing a stacked form of the display device according to one embodiment of the present specification.

### DETAILED DESCRIPTION

Advantages and features of the present specification and methods for achieving them will become clear with reference to embodiments described below in detail in conjunction with the accompanying drawings. However, the present specification is not limited to embodiments disclosed below but can be implemented in various different forms, the embodiments are merely provided to make the disclosure of the present specification complete and fully inform those skilled in the art to which the present specification pertains of the scope of the present specification. The same reference number indicates the same components throughout the specification.

When a first component is “connected to” or “coupled to” a second component, it includes both a case in which the first component is directly connected or coupled to the second component or a case in which other components are interposed therebetween. On the other hand, when the first component is “directly connected to” or “directly coupled to” the second component, it means that other components are not interposed therebetween. The term “and/or” includes cach of stated items and any combination of one or more stated items.

Terms used in the present specification are intended to describe the embodiments and are not intended to limit the present specification. In the present specification, the singular form also includes the plural form unless specifically stated in the phrase. The terms “comprises” and/or “comprising” used herein mean that the stated component, step, operation, and/or element do not preclude the presence or addition of one or more other components, steps, operations, and/or elements.

Although first, second, and the like are used to describe various components, it goes without saying that these components are not limited by these terms. These terms are only used to distinguish one component from another component.

Therefore, it goes without saying that a first component to be described below may be a second component within the technical spirit of the present specification.

The term “unit” may include any electrical circuitry, features, components, an assembly of electronic components or the like. That is, “unit” may include any processor-based or microprocessor-based system including systems using microcontrollers, integrated circuit, chip, microchip, reduced instruction set computers (RISC), application specific integrated circuits (ASICs), field-programmable gate arrays (FPGAs), graphical processing units (GPUs), logic circuits, and any other circuit or processor capable of executing the various operations and functions described herein. The above examples are examples only, and are thus not intended to limit in any way the definition or meaning of the term “unit.”

In some embodiments, the various units described herein may be included in or otherwise implemented by processing circuitry such as a microprocessor, microcontroller, or the like.

Unless otherwise defined, all terms (including technical and scientific terms) used in the specification may be used as meaning commonly understood by those skilled in the art to which the present specification pertains. In addition, terms defined in commonly used dictionaries are not construed ideally or excessively unless clearly and specially defined.

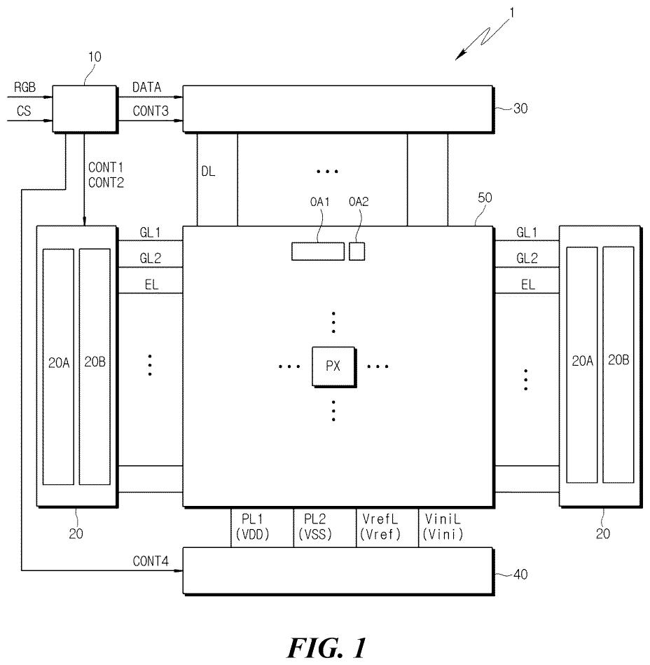

FIG. 1 is a block diagram schematically showing a display device according to one embodiment of the present specification.

Referring to FIG. 1, a display device 1 includes a timing controller 10, a gate driver 20, a data driver 30, a power supply unit 40, and a display panel 50.

The timing controller 10 may receive image signals RGB and a control signal CS from an external host system or the like. The image signals RGB may include a plurality of grayscale data. The control signal CS may include, for example, a horizontal synchronization signal, a vertical synchronization signal, and a main clock signal.

The timing controller 10 may process the image signals RGB and the control signal CS according to operating conditions of the display panel 60, and generate and output image data DATA, a gate driving control signal CONT1, an emission driving control signal CONT2, a data driving control signal CONT3, and a power supply control signal CONT4.

The gate driver 20 may include a scan driver 20A for generating scan signals based on the gate driving control signal CONT1 output from the timing controller 10. The scan driver 20A may provide the generated scan signals to pixel circuits PX through a plurality of gate lines GL1. In one embodiment, one pixel circuit PX may be configured to receive a plurality of scan signals with different waveforms. In the embodiment, the scan driver 20A may provide the plurality of scan signals to the pixel circuits PX through the corresponding gate lines GL1 and GL2.

The gate driver 20 may further include a light emitting driver 20B for generating emission control signals based on the emission driving control signal CONT2 output from the timing controller 10. The light emitting driver 20B may provide the generated emission control signals to the pixel circuits PX through emission lines EL.

The gate driver 20 may be configured in a form of a gate in panel mounted on the display panel 50. The gate driver 20 may be disposed at one side of the display panel 50 or both sides (e.g., left and right sides) of the display panel 50 as shown. According to a driving method, a panel design method, and the like, the gate driver 20 may be disposed at both sides (e.g., left and right sides) of the display panel 50 as shown or connected to two or more of four side surfaces of the display panel 50.

The data driver 30 may generate data signals based on the image data DATA and the data driving control signal CONT3 that are output from the timing controller 10. The data driver 30 may provide the generated data signals to the pixel circuits PX through a plurality of data lines DL.

The power supply unit 40 may generate a high potential driving voltage VDD and a low potential driving voltage VSS to be provided to the display panel 50 based on the power supply control signal CONT4. The power supply unit 40 may provide the generated driving voltages VDD and VSS to the pixel circuits PX through the corresponding voltage lines PL1 and PL2. In addition, the power supply unit 40 may further generate a reference voltage Vref and/or an initialization voltage Vini that are required for driving the pixel circuits PX and provide the reference voltage Vref and/or an initialization voltage Vini to the pixel circuits PX through the corresponding voltage lines VrefL and ViniL.

A plurality of pixel circuits PX (or referred to as “sub-pixel circuits”) are disposed on the display panel 50. For example, the pixel circuits PX may be arranged in a form of a matrix on the display panel 50. Pixel circuits PX disposed in one pixel row are connected to the same gate lines GL1 and GL2 and emission line EL, and pixel circuits PX disposed in one pixel column are connected to the same data line DL. The pixel circuits PX may emit light with brightness corresponding to the gate signal and the data signal that are supplied through the gate lines GL1 and GL2 and the data lines DL in response to the emission control signal applied through the emission line EL.

In one embodiment, each pixel circuit PX may display any one of red, green, and blue. In another embodiment, each pixel circuit PX may display any one of cyan, magenta, and yellow. In various embodiments, each pixel circuit PX may display any one of red, green, blue, and white.

In one embodiment, one or more optical areas OA1 and OA2 may be disposed in the display panel 50. The one or more optical areas OA1 and OA2 may be disposed to overlap one or more optical electronic devices, such as a photographing device, such as a camera (image sensor), or a detection sensor, such as a proximity sensor and an illuminance sensor.

For an operation of the optical electronic device, the one or more optical areas OA1 and OA2 may include a light transmission structure and have a transmittance at a selected (in some cases, predetermined) level or higher. The light transmission structure may be formed by patterning a cathode in a portion in which the pixel circuit PX is not disposed. The cathode may be removed using a laser or patterned by selectively forming the cathode through a cathode anti-deposition layer.

Alternatively, the light transmission structure may be formed by separating the light emitting element from the pixel circuit PX. In the embodiment, the light emitting element of the pixel circuit PX may be positioned on the optical areas OA1 and OA2, a plurality of transistors constituting the pixel circuit PX may be disposed near the optical areas OA1 and OA2, and the light emitting element and the pixel may be electrically connected through a transparent metal layer.

The number of pixel circuits PX per unit area in the one or more optical areas OA1 and OA2 may be smaller than the number of pixel circuits PX per unit area in the remaining areas excluding the optical areas OA1 and OA2. In other words, the resolution of the one or more optical areas OA1 and OA2 may be lower than the resolution of the remaining areas. The timing controller 10, the gate driver 20, the data driver 30, and the power supply unit 40 may each be configured as a separate integrated circuit (IC) or an IC in which at least some thereof are integrated.

In one embodiment, the display device I may be driven in a variable refresh rate mode in which a driving frequency may be changed. For example, the display device I may be driven at a refresh rate that is higher or lower than a selected (in some cases, predetermined) reference refresh rate. When the display device 1 is driven at a rate lower than the reference refresh rate, it can be referred to as “low-frequency driving,” and when the display device 1 is driven at a rate higher than the reference refresh rate, it can be referred to as “high-frequency driving.” The refresh rate may be determined according to the type of image to be displayed or the like, but is not limited thereto.

The timing controller 10 may generate the control signals CONT1 to CONT4 so that the pixel circuit PX may be driven at various refresh rates. For example, the timing controller 10 may change the refresh rate by changing a frequency of the clock signal included in the control signals CONT1 to CONT4, adjusting the timing of the horizontal synchronization signal or the vertical synchronization signal, or driving the gate driver 20 in a mask manner.

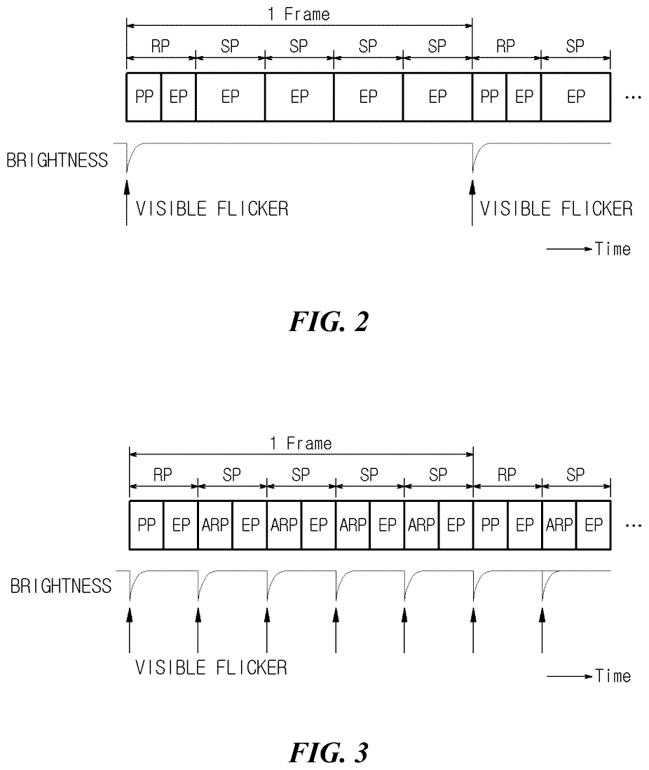

FIG. 2 is a method of driving the display device according to related art.

In the variable refresh rate mode, one frame may be configured in a combination of at least one refresh period RP and at least one skip period SP. During the refresh period RP, each pixel circuit PX (see FIG. 1) may be programmed with a new data voltage, and the light emitting element of the pixel circuit PX may emit light in response to the programmed data voltage. The refresh period RP may be subdivided into an initialization period, a sampling period, a hold period, and the like for data voltage programming. The refresh period RP may also be referred to as “refresh frame.”

A process of applying a new data voltage to the pixel circuit PX during the skip period SP is omitted. During the skip period SP, the light emitting element of each pixel circuit PX may emit light in response to the data voltage programmed during the previous refresh period RP. The skip period SP may be referred to as “skip frame,” “hold frame,” or the like.

In one embodiment, to change the refresh rate, a length of one frame may be changed by adjusting the number or lengths of skip periods SP. Then, the length of the refresh period RP may be sufficiently secured to allow the data voltage to be stably programmed.

In the embodiment, a generation cycle of the refresh period RP may be changed depending on the variable refresh rate. The generation cycle of the refresh period RP increases as the refresh rate decreases, and the number of skip periods SP between the refresh periods RP increases as the refresh rate decreases.

For example, the generation cycle of the refresh period RP may be 120/1 second at 120 Hz, 60/1 second at 60 Hz, 24/1 second at 24 Hz, and 1/1 second at 1 Hz. The number of skip periods SP positioned between two neighboring refresh periods RP may be 0 at 120 Hz, 1 at 60 Hz, 4 at 24 Hz, and 9 at 1 Hz, and in FIG. 2, an example of 24 Hz is shown. However, the present embodiment is not limited thereto.

The refresh period RP includes a programming period PP and an emission period EP. During the programming period PP, a new data voltage is programmed into the pixel circuits PX, and during the emission period EP, the pixel circuit PX emits light in response to the programmed data voltage.

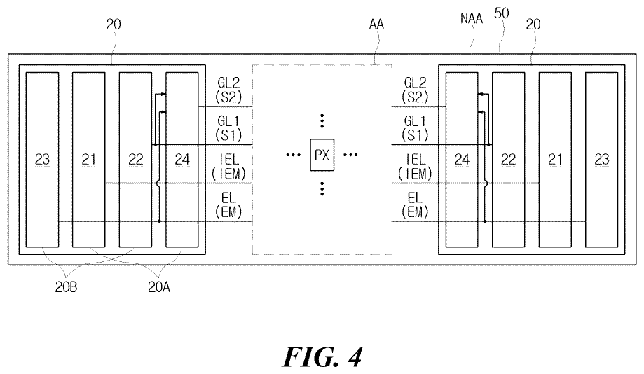

The skip period SP includes only the emission period EP in which the emission signal EM (see FIG. 4) has a turn-on level. During the emission period EP, the pixel circuits PX maintain the luminous brightness of the previous refresh period RP.

In one embodiment, a length of the emission period EP of the skip period SP may be larger than a length of the emission period EP of the refresh period RP. Therefore, comparing the brightness integral amount for a selected (in some cases, predetermined) time, the lower the refresh rate (i.e., the larger the number of skip periods SP), the relatively larger the brightness integral amount. For example, the brightness integral amount for the selected (in some cases, predetermined) time is larger at 60 Hz than at 120 Hz, larger at 24 Hz than at 60 Hz, and larger at 1 Hz than at 24 Hz.

Due to a difference in brightness integral amount according to the refresh rate, flicker may be visible when the refresh rate is changed.

FIG. 3 is a view showing a method of driving a display device according to an embodiment of the present specification.

In one embodiment, during the skip period SP, an anode of the light emitting element included in the pixel circuit PX (see FIG. 1) may be reset to a selected (in some cases, predetermined) reset voltage (e.g., an initialization voltage). In the embodiment, the skip period SP may be referred to as “anode initialization period” or “anode initialization frame.”

The refresh period RP includes a programming period PP and an emission period EP. During the programming period PP, a new data voltage is programmed into the pixel circuits PX, and during the emission period EP, the pixel circuit PX emits light in response to the programmed data voltage.

The skip period SP includes an anode initialization period ARP in which the emission signal EM (see FIG. 4) has a turn-off level and an emission period EP in which the emission signal EM has a turn-on level. During the anode initialization period ARP, a selected (in some cases, predetermined) reset voltage (e.g., an initialization voltage) is applied to the anode of the light emitting element included in the pixel circuits PX. During the period, the light emitting element may not emit light due to the reset voltage. During the emission period EP, the pixel circuits PX emit light with the luminous brightness of the immediately preceding refresh period RP.

A length of the anode initialization period ARP may be equal to a length of the programming period PP so that the brightness integral amounts of the skip period SP and the refresh period RP are equal to each other. As described above, in the embodiment including the anode initialization period ARP, deviation of the brightness integral amounts according to the refresh rate does not occur, and flicker due to the difference in brightness integral amounts can be suppressed.

FIG. 4 is a block diagram showing a configuration of a gate driver in the display device according to one embodiment of the present specification.

Referring to FIG. 4, the display panel 50 may include a display area AA in which images are displayed and a non-display area NAA in which images are not displayed near the display arca AA.

An array of pixel circuits PX is disposed in the display area AA. At least some of the driving units may be mounted on or connected to the non-display area NAA. For example, the gate driver 20 may be disposed at one side or both sides (e.g., left and right sides) as shown of the display area AA in the non-display area NAA. The gate drivers 20 disposed at both sides of the display area AA may be configured symmetrically (in a form of mirroring). Hereinafter, a configuration will be described based on the gate driver 20 disposed at the left side of the display area AA.

The gate driver 20 may include first to fourth shift registers 21, 22, 23, and 24. The first shift register 21 and the second shift register 22 may be the scan drivers, the third shift register 23 may be the light emitting driver, and the fourth shift register 24 may be an inverted driver.

The first and second shift registers 21 and 22 are configured to output scan signals. For example, the first shift register 21 may sequentially output a first scan signal S1 through the first gate lines GL1, and the second shift register 22 may sequentially output a second scan signal S2 through the second gate lines GL2.

Each of the first and second shift registers 21 and 22 may be composed of dependently connected stage circuits. Each stage circuit may be connected to the corresponding gate lines GL1 and GL2 to output the scan signals S1 and S2 to the gate lines GL1 and GL2.

The first and second scan signals S1 and S2 may be used to drive at least one transistor provided in the pixel circuit PX. For example, the first and second scan signals S1 and S2 may be used to program image data DATA (see FIG. 1) into the pixel circuit PX, initialize the voltage stored in the pixel circuit PX, or compensate the characteristics of the circuit element.

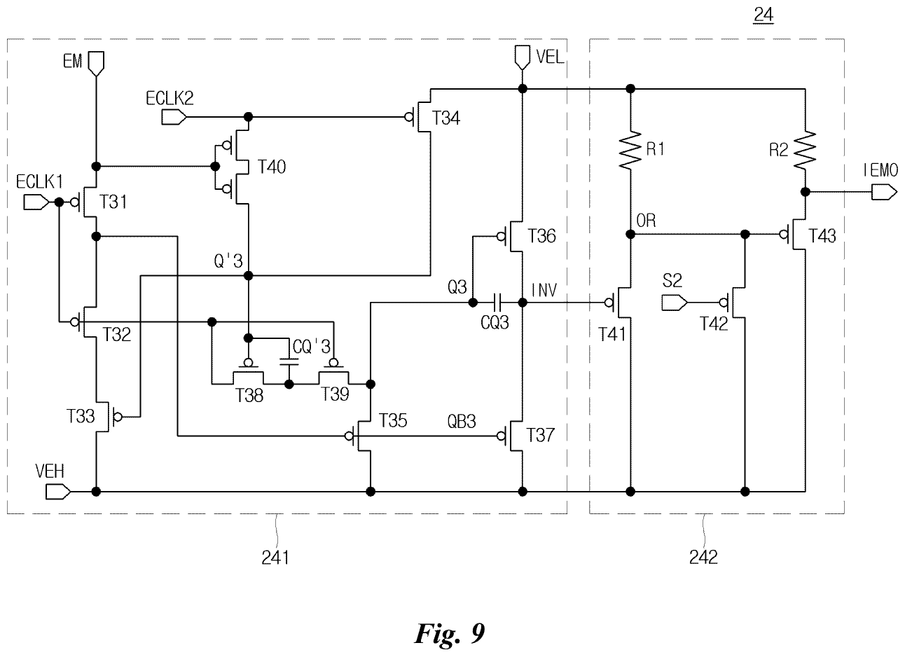

The third and fourth shift registers 23 and 24 are configured to output an emission signal and an inverted emission signal. For example, the third shift register 23 may output the emission signal EM through the emission lines EL, the fourth shift register 24 may output an inverted signal with a reversed phase with respect to the emission signal EM from a first inverting unit 241 (also referred to as a first inverting circuit 241; see FIG. 9), and a second inverting unit 242 (also referred to as a second inverting circuit 242; see FIG. 9) may output a second gate low voltage VEL as an inverted emission signal IEM through an inverted emission line IEL when at least one of an inverted signal generated from the first inverting unit 241 or the scan signal S2 output from the second shift register 22 has a turn-on level. In the embodiment, the fourth shift register 24 may be configured to receive the scan signal S2 output from the second shift register 22 and the emission signal EM output from the third shift register 23 and configured to generate and output the inverted emission signal IEM by providing at least one circuit element for inverting a phase of the input emission signal EM.

The emission signal EM and the inverted emission signal IEM may be used to drive at least one transistor provided in the pixel circuit PX. For example, the emission signal EM may be used to change or control an emission time of the pixel circuit PX.

In the shown embodiment, the first and second shift registers 21 and 22 may be disposed adjacent to the display area AA, and the third shift register 23 may be disposed relatively away from the display area AA. In addition, the fourth shift register 24 that outputs the inverted emission signal IEM may be disposed relatively adjacent to the display area AA compared to the third shift register 23 to receive the scan signal S2 output from the second shift register 22 to the pixel circuits PX and receive the emission signal EM output from the third shift register 23 to the pixel circuits PX.

However, the arrangement of the shift registers 21, 22, 23, and 24 is not limited to that shown. The arrangement of the shift registers 21, 22, 23, and 24 may be changed variously in the possible range to decrease the size of the non-display area NAA and decrease lengths and amounts of lines according to the specifications of the display panel 50.

In addition, although not shown, the voltage lines VrefL and ViniL supplying the reference voltage Vref and/or the initialization voltage Vini may be disposed between the gate driver 20 and the display area AA.

The voltage lines VrefL and ViniL may be disposed adjacent to the display area AA in the order of the initialization voltage line ViniL and the reference voltage line VrefL. Alternatively, the voltage lines VrefL and ViniL may be disposed adjacent to the display area AA in the order of the reference voltage line VrefL and the initialization voltage line ViniL.

The voltage lines VrefL and ViniL may be disposed symmetrically at both sides of the display area AA. The voltage lines VrefL and ViniL are not limited thereto and may be located only at one of the left and right sides, and even when positioned at one side, the position at the left or right side is not limited.

The voltage lines VrefL and ViniL may be branched, respectively to supply the reference voltage Vref and the initialization voltage Vini of a DC voltage from the power supply unit 40 to the pixel circuit PX.

The voltage lines VrefL and ViniL may be made of the same material at the same layer as the source or drain electrode 140 and may also be made of the same material at the same layer as a connecting electrode 155.

At least some branched from the voltage lines VrefL and ViniL and connected to the pixel circuit PX may be made of the same material at the same layer as the gate electrodes 125 and 126, or at least some may be made of the same material at the same layer as the touch electrodes 194, 195, and 196 or made of the same material at the same layer as the semiconductor layers 115 and 116.

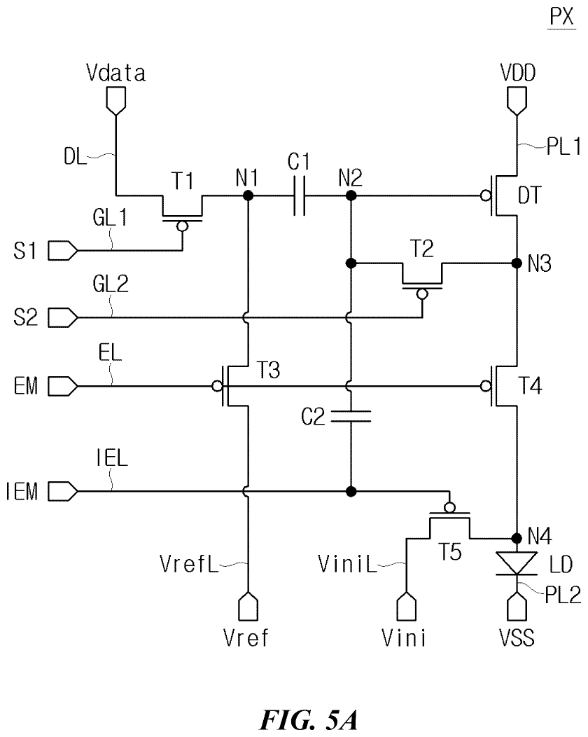

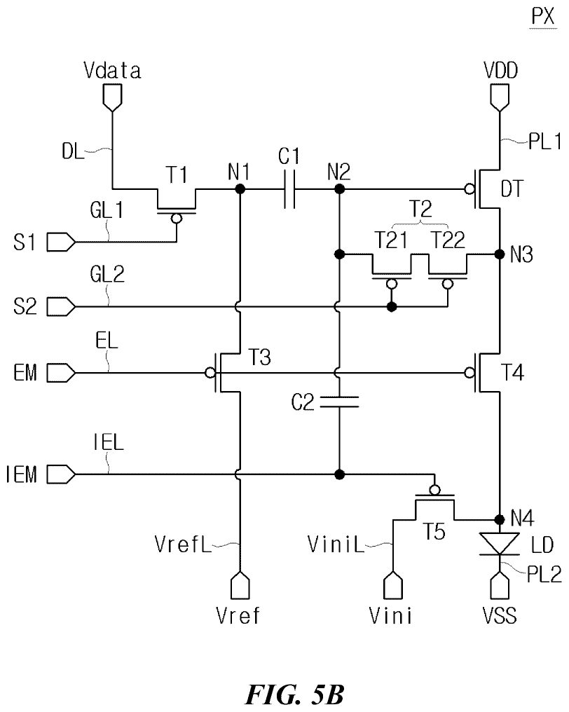

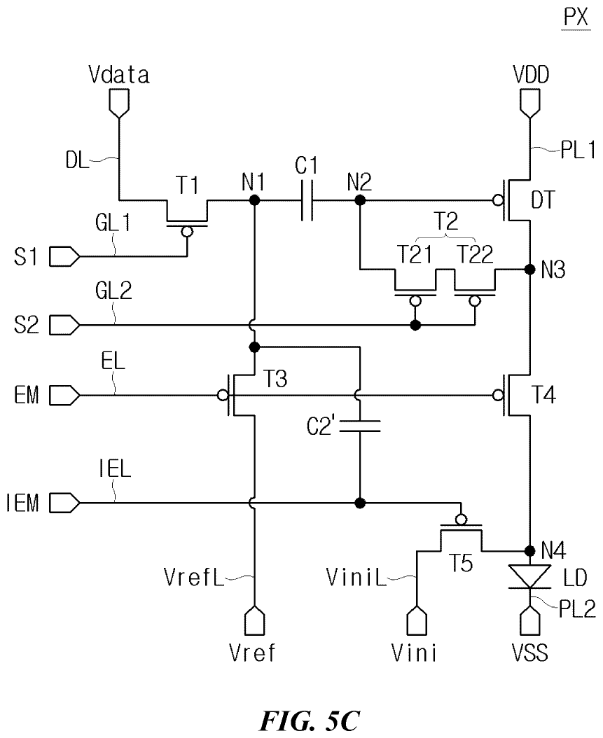

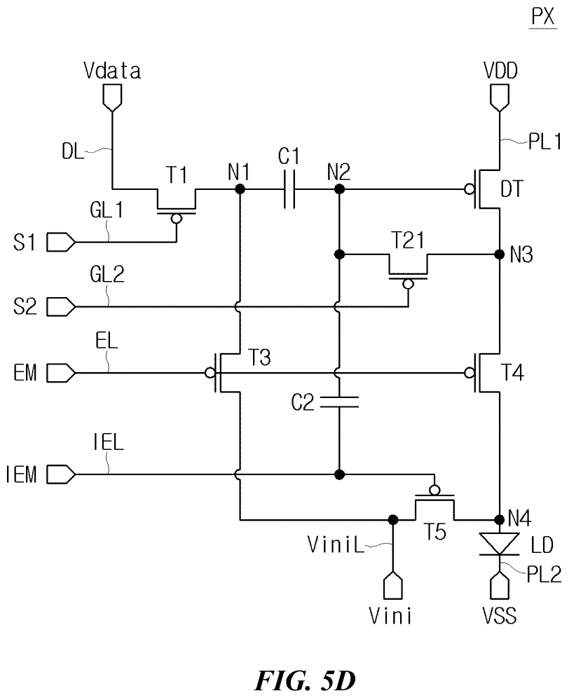

FIGS. 5A to 5D are circuit diagrams of pixels according to a first embodiment. In FIGS. 5A to 5D, for convenience of description, a pixel connected to an n^{th} pixel row (n is an integer larger than 0) is shown as an example.

Referring to FIGS. 5A and 5B, the pixel circuit PX according to one embodiment may include a driving transistor DT, a light emitting element LD connected to the driving transistor DT, and a control circuit for controlling the amount of driving current to be applied to the light emitting element LD through the driving transistor DT. For example, the control circuit may include first to fifth transistors T1 to T5 and first and second capacitors C1 and C2.

A first electrode of the driving transistor DT is formed to receive the high potential driving voltage VDD (connected to the high potential driving voltage line PL1), and a second electrode thereof is connected to a third node N3. A gate electrode of the driving transistor DT is connected to a second node N2. The driving transistor DT may be turned on according to a voltage applied to the second node N2 to control the amount of driving current flowing to the light emitting element LD.

A first electrode of the first transistor T1 is connected to the data line DL, and a second electrode thereof is connected to a first node N1. A gate electrode of the first transistor T1 may be connected to the first gate line GL1 to receive the first scan signal S1. The first transistor T1 may be turned on according to the first scan signal S1 applied to the first gate line GL1 to transmit a data voltage Vdata applied to the data line DL to the first node N1. The first transistor T1 may be referred to as “first switching transistor.”

The first capacitor C1 is connected between the first node N1 and the second node N2. The first capacitor C1 may store a voltage corresponding to a voltage difference between the first node Nl and the second node N2. For example, the first capacitor C1 may store a voltage corresponding to a difference between the data voltage Vdata applied to the data line DL and a voltage at the second node N2 and maintain the stored voltage for one frame period, thereby stabilizing the voltage of the gate electrode (i.e., the second node N2) of the driving transistor DT. The first capacitor C1 may be referred to as “storage capacitor.”

The second transistor T2 is connected between the second node N2 and the third node N3. A gate electrode of the second transistor T2 may be connected to the second gate line GL2 to receive the second scan signal S2. The second transistor T2 may be turned on according to the second scan signal S2 applied to the second gate line GL2 to electrically connect the gate electrode (second node N2) of the driving transistor DT with the second electrode (third node N3). The second transistor T2 may be referred to as “second switching transistor.”

A first electrode of the third transistor T3 is formed to receive the reference voltage Vref (connected to a reference voltage line Vref1), and a second electrode thereof is connected to the first node N1. A gate electrode of the third transistor T3 may be connected to the emission line EL to receive the emission signal EM. The third transistor T3 may be turned on according to the emission signal EM applied to the emission line EL to transmit the reference voltage Vref to the first node N1. The third transistor T3 may be referred to as “third switching transistor.”

The fourth transistor T4 is connected between the third node N3 and a fourth node N4. A gate electrode of the fourth transistor T4 may be connected to the emission line EL to receive the emission signal EM. The fourth transistor T4 may be turned on according to the emission signal EM applied to the emission line EL to electrically connect the driving transistor DT (third node N3) with the light emitting clement LD (fourth node N4). The fourth transistor T4 may be referred to as “light emitting transistor.”

A first electrode of the fifth transistor T5 is formed to receive the initialization voltage Vini, and a second electrode thereof is connected to the fourth node N4. A gate electrode of the fifth transistor T5 may be connected to the inverted emission line IEL to receive the inverted emission signal IEM. The fifth transistor T5 may be turned on according to the inverted emission signal IEM applied to the inverted emission line IEL to apply the initialization voltage Vini to the anode (fourth node N4) of the light emitting element LD. The fifth transistor T5 may be referred to as “initialization transistor.”

A second capacitor C2 is connected between the inverted emission line IEL and the second node N2. When the inverted emission signal IEM is applied to the inverted emission line IEL, the second capacitor C2 may be formed to transmit a coupling voltage to the second node N2. The second capacitor C2 may be referred to as “coupling capacitor.”

The anode of the light emitting element LD may be connected to the fourth node N4, and the cathode thereof may be connected to the low potential driving voltage VSS. When the driving transistor DT and the fourth transistor T4 are turned on, a current path may be formed between the high potential driving voltage VDD and the low potential driving voltage VSS to allow the driving current to flow to the light emitting element LD. The light emitting element LD may emit light with brightness corresponding to the amount of driving current applied.

Compared to the embodiment of FIG. 5A, referring to FIG. 5B, the second transistor T2 may be formed of a plurality of second sub-transistors T21 and T22 connected in series. Gate electrodes of the second sub-transistors T21 and T22 may be connected to the second gate line GL2 to receive the second scan signal S2. The second transistor T2 may be turned on according to the second scan signal S2 applied to the second gate line GL2 to electrically connect the gate electrode (second node N2) of the driving transistor DT with the second electrode (third node N3).

In the shown embodiment, the second transistor T2 is formed of two sub-transistors T21 and T22, but the embodiment is not limited thereto. In another embodiment, the second transistor T2 may be formed of a larger number of sub-transistors.

Referring to FIG. 5C, a second capacitor C2′ is connected between the inverted emission line IEL and the first node N1. When the inverted emission signal IEM is applied to the inverted emission line IEL, the second capacitor C2′ may be formed to transmit a coupling voltage to the first node N1. The second capacitor C2′ be referred to as “coupling capacitor.”

Referring to FIG. 5D, a voltage line ViniL may be formed to apply the same initialization voltage Vini to the first electrode of the third transistor T3 and the first electrode of the fifth transistor T5.

In the embodiments shown in FIGS. 5A to 5D, the pixel circuit PX includes a low temperature poly-silicon (LTPS) thin film transistor.

The LTPS thin film transistor includes a gate electrode, a source electrode, and a drain electrode. The LTPS thin film transistor has an active layer made of polysilicon. The LTPS thin film transistor may be formed as a p-type thin film transistor or an n-type thin film transistor. The LTPS thin film transistor has high electron mobility, and thus has fast driving characteristics.

However, the present embodiment is not limited thereto. In another embodiment, at least one of the transistors DT and T1 to T6 may be formed as an oxide semiconductor thin film transistor.

The oxide semiconductor thin film transistor includes a gate electrode, a source electrode, and a drain electrode. The oxide semiconductor thin film transistor has an active layer formed of an oxide semiconductor. Here, the oxide semiconductor may be set to an amorphous or crystalline oxide semiconductor. The oxide semiconductor thin film transistor may be formed as an n-type transistor. The oxide semiconductor thin film transistor may be processed at low temperatures and has lower charge mobility than the LTPS thin film transistor. The oxide semiconductor thin film transistor has excellent off-current characteristics.

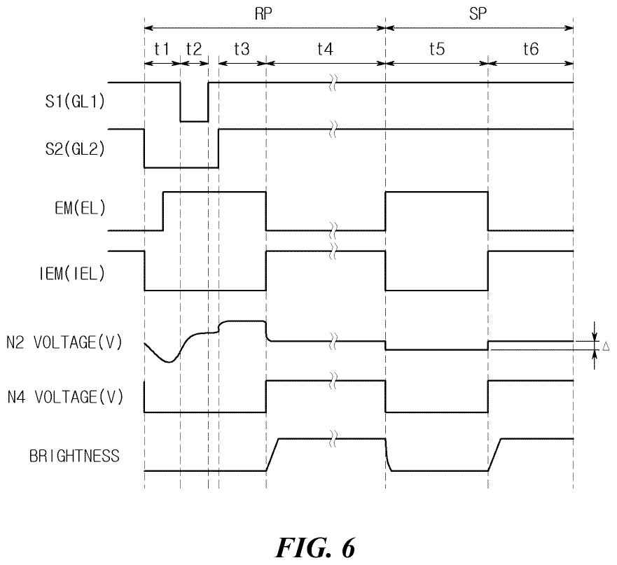

FIG. 6 is a view showing a method of driving the pixels shown in FIGS. 5A to 5D.

Referring to FIGS. 6 and 5A to 5D, in the variable refresh rate mode, 1 frame may be configured in a combination of at least one refresh period RP and at least one skip period SP.

The refresh period RP may include an initialization period t1, a sampling period t2, a hold period t3, and an emission period t4.

During the initialization period t1, the second scan signal S2 at the turn-on level is further applied to turn on the second transistor T2. In addition, during the initialization period t1, the emission signal EM at the turn-on level is applied to turn on the third transistor T3 and the fourth transistor T4. Therefore, during the initialization period t1, the reference voltage Vref is applied to the first node N1, and the initialization voltage Vini is applied to the fourth node N4 and the third node N3.

When the second transistor T2 is turned on, a voltage at the third node N3 may be transmitted to the second node N2. Therefore, an initial voltage at the second node N2 may correspond to the initialization voltage Vini. During the initialization period t1, the first capacitor C1 may be gradually charged to a voltage corresponding to a difference between the reference voltage Vref and the initialization voltage Vini. In addition, during the initialization period t1, the voltage at the second node N2 may gradually reach the voltage corresponding to the difference between the reference voltage Vref and the initialization voltage Vini in response to the charging voltage of the first capacitor C1.

Meanwhile, during the initialization period t1, the anode of the light emitting element LD may be initialized to the initialization voltage Vini in response to a voltage at the fourth node N4

During the sampling period t2, the first scan signal S1 at the turn-on level is further applied to turn on the first transistor T1. In addition, during the sampling period t2, the emission signal EM may be switched to the turn-off level to turn off the third transistor T3 and the fourth transistor T4. Conversely, during the sampling period t2, the inverted emission signal IEM is switched to the turn-on level. Then, the fifth transistor T5 may be turned on in response to the inverted emission signal IEM at the turn-on level. Therefore, during the sampling period t2, the data voltage Vdata applied to the data line DL is applied to the first node N1, and the initialization voltage Vini is applied to the fourth node N4.

During the sampling period t2, the first capacitor C1 may be gradually charged to a voltage corresponding to a difference between the data voltage, the reference voltage Vref, and the initialization voltage Vini. In addition, during the sampling period t2, the voltage at the second node N2 may gradually reach the voltage corresponding to the difference between the data voltage Vdata, the reference voltage Vref, and the initialization voltage Vini in response to the charging voltage of the first capacitor C1.

When the charging voltage of the first capacitor C1 is transmitted to the gate electrode of the driving transistor DT, a source-gate voltage of the driving transistor DT is higher than a threshold voltage Vth, and thus the driving transistor DT may be turned on. In this case, a source-drain current of the driving transistor DT may be determined according to the data voltage Vdata, the reference voltage Vref, the initialization voltage Vini, and the threshold voltage of the driving transistor DT.

The driving transistor DT may supply the source-drain current to the third node N3 until the source-gate voltage reaches the threshold voltage of the driving transistor DT. In addition, the second transistor T2 may supply the voltage at the third node N3 to the second node N2. In such a manner, while the driving transistor DT is turned on, the voltage at the second node N2 and the source-drain current of the driving transistor DT may be changed, and the voltage at the second node N2 may eventually converge to a voltage corresponding to a difference between the data voltage Vdata and the threshold voltage Vth of the driving transistor DT.

Meanwhile, during the sampling period t2, since the initialization voltage Vini is applied to the fourth node N4 through the fifth transistor T5, the anode of the light emitting element LD may maintain the initialization voltage Vini in response to the voltage at the fourth node N4.

During the hold period t3, the first scan signal S1 and the second scan signal S1 are switched to the turn-off level to turn off the first transistor T1 and the second transistor T2. During the hold period t3, the voltage at the second node N2 may be maintained stably through the first capacitor C1.

During the emission period t4, the emission signal EM at the turn-on level is applied to turn on the third transistor T3 and the fourth transistor T4. During the emission period t4, a current path from the high potential driving voltage VDD to the light emitting element LD via the driving transistor DT is formed. Therefore, a driving current with a magnitude corresponding to the voltage programmed into the driving transistor DT may flow along the current path to allow the light emitting element LD to emit light with the corresponding brightness.

The skip period SP may include an anode initialization period t5 and an emission period t6.

During the anode initialization period t5, the emission signal EM may be switched to the turn-off level to turn off the third transistor T3 and the fourth transistor T4. Conversely, during the anode initialization period t5, the inverted emission signal IEM is switched to the turn-on level. Then, the fifth transistor T5 may be turned on in response to the inverted emission signal IEM at the turn-on level. Therefore, during the anode initialization period t5, the initialization voltage Vini is applied to the fourth node N4.

During the anode initialization period t5, the light emitting element LD does not emit light due to the initialization voltage Vini applied to the anode of the light emitting element LD. Instead, the voltage of the gate electrode of the driving transistor DT may be maintained at the voltage programmed during the previous refresh period RP by the first capacitor C1.

During the anode initialization period t5, when the inverted emission signal IEM is applied to the inverted emission line IEL, a parasitic capacitance (coupling voltage) may be generated in the second capacitor C2, and thus the voltage at the second node N2 may be decreased (kickbacked) by a selected (in some cases, predetermined) level A. When the source voltage of the driving transistor DT is maintained, a decrease in the voltage at the second node N2 increases the source-gate voltage of the driving transistor DT. Therefore, the driving transistor DT may maintain the turn-on state during the anode initialization period t5, and the hysteresis of the driving transistor DT may be decreased.

In this case, in the case of the pixel circuit PX of FIG. 5C, since one end of the second capacitor C2′ is connected to the first node N1 rather than the second node N2, the voltage at the first node N1 may be decreased (kickbacked) by a selected (in some cases, predetermined) level A, and the source-gate voltage of the driving transistor DT may be increased according to a change in voltage at the first node N1.

Meanwhile, during the anode initialization period t5, since the initialization voltage Vini is directly applied to the anode of the light emitting element LD, the voltage of the anode may be discharged at a relatively fast rate, thereby minimizing the charging delay of the light emitting clement LD. Through the anode initialization, deviation of the brightness integral amount according to the refresh rate does not occur, and flicker due to the difference in the brightness integral amount can be suppressed.

During the emission period t6, the emission signal EM at the turn-on level is applied to turn on the third transistor T3 and the fourth transistor T4. During the emission period t4, the light emitting element LD may emit light with the brightness corresponding to the voltage programmed during the previous refresh period RP.

Meanwhile, during the anode initialization period t5 before the emission period t6, the anode of the light emitting element LD is charged to the initialization voltage Vini. Therefore, during the emission period t6, the brightness of the light emitting element LD may reach a target brightness more quickly, thereby minimizing the charging delay of the light emitting element LD. In particular, since the initialization voltage Vini may be separated from the reference voltage Vref and supplied to the anode of the light emitting element LD, the voltage level of the initialization voltage Vini may be independently adjusted, and the charging and discharging delay timing of the light emitting element LD may be controlled effectively.

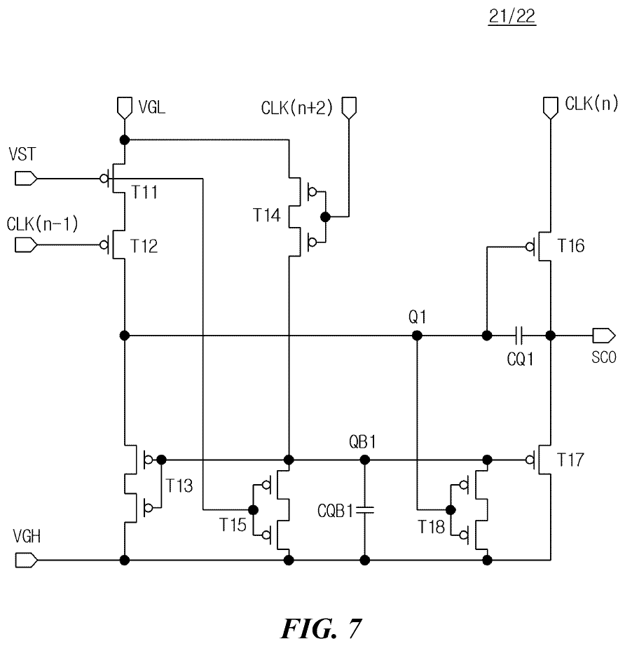

FIG. 7 is a block diagram showing a configuration of a scan driver in the display device according to one embodiment of the present specification.

Referring to FIG. 7, the first shift register 21 and/or the second shift register 22 operating as the scan drivers may include a 1-1 transistor T11 to a 1-8 transistor T18, a 1-1 capacitor CQ1, and a 1-2 capacitor CQB1.

In the present specification, the transistors included in the first shift register 21 and/or the second shift register 22 can be implemented as p-type thin film transistors, but are not limited thereto.

A gate electrode of the 1-1 transistor T11 is connected to an input terminal of a scan start signal VST, a first electrode thereof is connected to an input terminal of a first gate low voltage VGL, and a second electrode thereof is connected to a 1-2 transistor T12 switched by a (n−1)^{th} scan clock signal CLK(n−1).

A gate electrode of the 1-2 transistor T12 is connected to an input terminal of the (n−1)^{th} scan clock signal CLK(n−1), a first electrode thereof is connected to a second electrode of the 1-1 transistor T11, and a second electrode thereof is connected to a Q1 node.

A gate electrode of the 1-3 transistor T13 is connected to a QB1 node, a first electrode thereof is connected to a Q1 node and the second electrode of the 1-2 transistor T12, and a second electrode thereof is connected to an input terminal of a first gate high voltage VGH.

The 1-1 transistor T11, the 1-2 transistor T12, and the 1-3 transistor T13 activate or deactivate the Q1 node. When both the 1-1 transistor T11 and the 1-2 transistor T12 are turned on, the Q1 node is activated to the first gate low voltage VGL. The 1-2 transistor T12 is turned on according to the (n−1)^{th} scan clock signal CLK(n−1) whose phase is carlier than that of an n^{th} scan clock signal CLK(n) to activate the Q1 node to the first gate low voltage VGL. In addition, the 1-1 transistor T11 is turned on according to the scan start signal VST synchronized with the (n−1)^{th} scan clock signal CLK(n−1) to activate the Q1 node to the first gate low voltage VGL.

A gate electrode of the 1-4 transistor T14 is connected to an input terminal of an (n+2)^{th} scan clock signal CLK(n+2) whose phase is later than that of the n^{th} scan clock signal CLK(n), a first electrode thereof is connected to an input terminal of the first gate low voltage VGL, and a second electrode thereof is connected to the QB1 node.

A gate electrode of the 1-5 transistor T15 is connected to an input terminal of the scan start signal VST, a first electrode thereof is connected to the QB1 node, and the second electrode thereof is connected to an input terminal of the first gate high voltage VGH.

The 1-4 transistor T14 is turned on according to an (n+2)^{th} scan clock signal CLK(n+2) to activate the QB1 node to the first gate low voltage VGL. The 1-5 transistor T15 is turned on according to the scan start signal VST to deactivate the QB1 node to the first gate high voltage VGH.

A gate electrode of the 1-6 transistor T16 is connected to the Q1 node, a first electrode thereof is connected to an input terminal of the n^{th} scan clock signal CLK(n), and a second electrode thereof is connected to an output terminal SCO of the scan driver. The 1-6 transistor T16 is a pull-up transistor that outputs the scan signals S1 and S2 of the first gate low voltage VGL to the output terminal SCO of the scan driver when a potential at the Q1 node is boosted according to the n^{th} scan clock signal CLK(n).

A gate electrode of the 1-7 transistor T17 is connected to the QB1 node, a first electrode thereof is connected to the output terminal SCO of the scan driver, and a second electrode thereof is connected to the input terminal of the first gate high voltage VGH. The 1-7 transistor T17 is a pull-down transistor that outputs the scan signals S1 and S2 of the first gate high voltage VGH to the output terminal SCO of the scan driver when the QB1 node is activated.

A gate electrode of the 1-8 transistor T18 is switched by the Q1 node, a first electrode thereof is connected to the QB1 node, and a second electrode thereof is connected to the input terminal of the first gate high voltage VGH.

The 1-8 transistors T18 control a potential at the Q1 node and a potential at the QB1 node conversely, and when the Q1 node is activated to the first gate low voltage VGL, the QB1 node is deactivated to the first gate high voltage VGH. When the 1-8 transistor T18 is turned off, the QB1 node is activated to the first gate low voltage VGL.

Since the QB1 node should maintain the activation state for a relatively long time in one frame, the first shift register 21 and/or the second shift register 22 according to one embodiment of the present specification may further include a 1-2 capacitor CQB1 of which one end is connected to contact points of the 1-5 transistor T15, the 1-8 transistor T18, and the QB1 node and the other end is connected to contact points of the 1-5 transistor T15, the 1-8 transistor T18, and the input terminal of the first gate high voltage VGH. The 1-2 capacitor CQB1 may be a stabilization capacitor.

The 1-1 capacitor CQ1 is connected between the Q1 node and the output terminal SCO of the scan driver. When the n^{th} scan clock signal CLK(n) is decreased to the first gate low voltage VGL, a potential of the Q1 node is decreased to a boosting level lower than the first gate low voltage VGL due to the coupling effect of the 1-1 capacitor CQ1. Due to such bootstrapping, a potential of the output terminal SCO of the scan driver is quickly decreased to the first gate low voltage VGL. Using the bootstrapping effect, the scan signals S1 and S2 of the first gate low voltage VGL may be output quickly without distortion or delay. In other words, the 1-1 capacitor CQ1 may be a bootstrap capacitor.

As shown in FIG. 7, the 1-3 transistor T13, the 1-5 transistor T15, and the 1-8 transistor T18 may each be designed in a dual gate structure to suppress a leakage current when turned off. In the dual gate structure, two gate electrodes are connected to have the same potential, and a channel length is larger than that of a single gate structure. As the channel length increases, a resistance increases, and thus a leakage current is reduced upon turn-off, thereby securing operational stability.

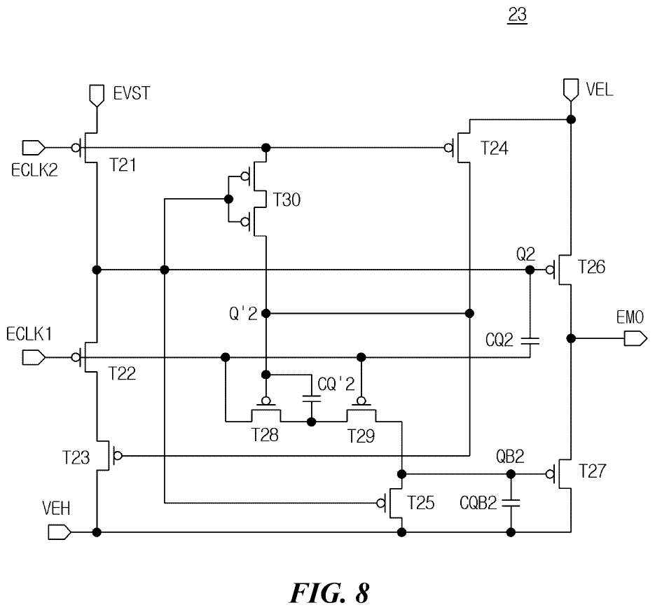

FIG. 8 is a block diagram showing a configuration of a light emitting driver in the display device according to one embodiment of the present specification.

Referring to FIG. 8, the third shift register 23 operating as the light emitting driver may include a 2-1 transistor T21 to a 2-10 transistor T30, and a 2-1 capacitor CQ2 to a 2-3 capacitor CQ′2.

The 2-1 transistor T21 to the 2-10 transistor T30 included in the third shift register 23 can be implemented as p-type thin film transistors, but are not limited thereto. The 2-1 transistor T21 to the 2-10 transistor T30 implemented as the p-type thin film transistors are turned on under a condition in which a low voltage is applied and turned off under a condition in which a high voltage is applied.

The 2-1 transistor T21 has a gate electrode connected to an input terminal of a second emission clock signal ECLK2, a first electrode connected to an input terminal of an emission start signal EVST, and a second electrode connected to a first electrode of the 2-2 transistor T22 and the Q2 node. The 2-1 transistor T21 is turned on or off in response to the second emission clock signal ECLK2.

The 2-2 transistor T22 has a gate electrode connected to an input terminal of a first emission clock signal ECLK1, a first electrode connected to a second electrode of the 2-1 transistor T21 and the Q2 node, and a second electrode connected to a first node of the 2-3 transistor T23. The 2-2 transistor T22 is turned on or off in response to the first emission clock signal ECLK1.

The 2-3 transistor T23 has a gate electrode connected to a second electrode of the 2-4 transistor T24, a first electrode connected to the second electrode of the 2-2 transistor T22, and a second electrode connected to an input terminal of a second gate high voltage VEH. When the 2-4 transistor T24 is turned on, the 2-3 transistor T23 is turned on in response to the second gate low voltage VEL.

The 2-4 transistor T24 has a gate electrode connected to the second emission clock signal ECLK2, a first electrode connected to an input terminal of the second gate low voltage VEL, and the second electrode connected to the gate electrode of the 2-3 transistor T23. The 2-4 transistor T24 is turned on or off in response to the second emission clock signal ECLK2. The 2-4 transistor T24 is turned on or off together with the 2-1 transistor T21 at the same time.

The 2-5 transistor T25 has a gate electrode connected to the Q2 node, a first electrode connected to a second electrode of the 2-9 transistor T29, and a second electrode connected to the input terminal of the second gate high voltage VEH. The 2-5 transistor T25 is turned on or off in response to a potential at the Q2 node.

The 2-6 transistor T26 has a gate electrode connected to the Q2 node and one end of the 2-1 capacitor CQ2, a first electrode connected to the input terminal of the second gate low voltage VEL, and a second electrode connected to an output terminal EMO of the light emitting driver. The 2-6 transistor T26 is turned on or off in response to the potential of the Q2 node.

The 2-7 transistor T27 has a gate electrode connected to a QB2 node, a first electrode connected to the output terminal EMO of the light emitting driver, and a second electrode connected to the input terminal of the second gate high voltage VEH. The 2-7 transistor T27 is turned on or off in response to a potential at the QB2 node.

The 2-8 transistor T28 has a gate electrode connected to a Q′2 node, a first electrode connected to an input terminal of the first emission clock signal ECLK1, and a second electrode connected to a first electrode of the 2-9 transistor T29. The 2-8 transistor T28 is turned on or off in response to a potential at the Q′2 node.

The 2-9 transistor T29 has a gate electrode connected to the input terminal of the first emission clock signal ECLK1, a first electrode connected to a second electrode of the 2-8 transistor T28, and a second electrode connected to a first electrode of the 2-5 transistor T25 and the QB2 node. The 2-9 transistor T29 is turned on or off in response to the first emission clock signal ECLK1.

The 2-10 transistor T30 has a gate electrode connected to the Q2 node, a first electrode connected to the input terminal of the second emission clock signal ECLK2, and a second electrode connected to the Q′2 node. The 2-10 transistor T30 is turned on or off in response to the potential at the Q2 node.

The 2-1 capacitor CQ2 has one end connected to the Q2 node and the other end connected to the input terminal of the first emission clock signal ECLK1. The 2-2 capacitor CQ′2 has one end connected to the Q′2 node and the other end connected to the second electrode of the 2-8 transistor T28. A 2-3 capacitor CQB2 has one end connected to the QB2 node and the other end connected to an input terminal of the second gate high voltage VEH.

The 2-1 capacitor CQ2 and the 2-2 capacitor CQ′2 may operate as the bootstrap capacitors, and the 2-3 capacitor CQB2 may operate as the stabilization capacitor.

In addition, the 2-1 capacitor CQ2 or the 2-2 capacitor CQ′2 may be designed to have a larger capacity than the 2-3 capacitor CQB2. In other words, the 2-1 capacitor CQ2 or the 2-2 capacitor CQ′2 may have a larger arca than the 2-3 capacitor CQB2.

The transistors included in the third shift register 23 are shown as being implemented as a single gate structure, but are not limited thereto, and the 2-1 transistor T21 to the 2-5 transistor T25, and the 2-8 transistor T28 to the 2-10 transistor T30 excluding the 2-6 transistor T26 and the 2-7 transistor T27 can be implemented as a dual gate structure to prevent current leakage and improve driving reliability. In addition, some transistors may be formed in a dual gate structure, and other transistors may be formed in a single gate structure.

FIG. 9 is a block diagram showing a configuration of an inverted gate driver in the display device according to one embodiment of the present specification.

Referring to FIG. 9, the fourth shift register 24 operating as the inverted driver may include a 3-1 transistor T31 to a 3-13 transistor T43, and a 3-1 capacitor CQ3 to a 3-4 capacitor CQ′3.

The 3-1 transistor T31 to the 3-13 transistor T43 included in the fourth shift register 24 can be implemented as p-type thin film transistors, but are not limited thereto. The 3-1 transistor T31 to the 3-13 transistor T43 implemented as the p-type thin film transistors are turned on under a condition in which a low voltage is applied and turned off under a condition in which a high voltage is applied.

In the fourth shift register 24 formed of the 3-1 transistor T31 to the 3-13 transistor T43, the 3-1 transistor T31 to the 3-10 transistor T40 may be included in the first inverting unit 241. In addition, the 3-11 transistor T41 to 3-13 transistor T43 may be included in the second inverting unit 242.

The 3-1 transistor T31 has a gate electrode connected to the input terminal of the first emission clock signal ECLK1, a first electrode connected to an input terminal of the emission signal EM output from the third shift register 23, and a second electrode connected to a QB3 node. The 3-1 transistor T31 is turned on or off in response to the first emission clock signal ECLK1.

The 3-2 transistor T32 has a gate electrode connected to the input terminal of the first emission clock signal ECLK1, a first electrode connected to a second electrode of the 3-1 transistor T31, and a second electrode connected to a first electrode of the 3-3 transistor T33. The 3-2 transistor T32 is turned on or off in response to the first emission clock signal ECLK1. The 3-2 transistor T32 is turned on or off together with the 3-1 transistor T31 at the same time.

The 3-3 transistor T33 has a gate electrode connected to a second electrode of the 3-4 transistor T34, a first electrode connected to a second electrode of the 3-2 transistor T32, and a second electrode connected to the input terminal of the second gate high voltage VEH. When the 3-4 transistor T34 is turned on, the 3-3 transistor T33 is turned on in response to the second gate low voltage VEL.

The 3-4 transistor T34 has a gate electrode connected to the input terminal of the second emission clock signal ECLK2, a first electrode connected to the input terminal of the second gate low voltage VEL, and a second electrode connected to the first electrode of the 3-3 transistor T33. The 3-4 transistor T34 is turned on or off in response to the second emission clock signal ECLK2.

The 3-5 transistor T35 has a gate electrode connected to the QB3 node and the second electrode of the 3-1 transistor T31, a first electrode connected to the Q3 node and a second electrode of the 3-9 transistor T39, and a second electrode connected to the input terminal of the second gate high voltage VEH. The 3-5 transistor T35 is turned on or off in response to a potential at the QB3 node.

The 3-6 transistor T36 has a gate electrode connected to the Q3 node and one end of the 3-1 capacitor CQ3, a first electrode connected to the input terminal of the second gate low voltage VEL, and a second electrode connected to an INV node. The 3-6 transistor T36 is turned on or off in response to the potential at the Q3 node.

The 3-7 transistor T37 has a gate electrode connected to the QB3 node, a first electrode connected to a second electrode of the 3-6 transistor T36, and a second electrode connected to the input terminal of the second gate high voltage VEH. The 3-7 transistor T37 is turned on or off in response to the potential at the QB3 node.

The 3-8 transistor T38 has a gate electrode connected to a Q′3 node, a first electrode connected to the input terminal of the first emission clock signal ECLK1, and a second electrode connected to a first electrode of the 3-9 transistor T39. The 3-8 transistor T38 is turned on or off in response to a potential at the Q′3 node.

The 3-9 transistor T39 has a gate electrode connected to the input terminal of the first emission clock signal ECLK1, a first electrode connected to a second electrode of the 3-8 transistor T38, and a second electrode connected to a first electrode of the 3-5 transistor T35 and the Q3 node. The 3-9 transistor T39 is turned on or off in response to the first emission clock signal ECLK1.

The 3-10 transistor T40 has a gate electrode connected to the input terminal of the emission signal EM output from the third shift register 23, a first electrode connected to the input terminal of the second emission clock signal ECLK2, and a second electrode connected to the Q′3 node. The 3-10 transistor T40 is turned on or off in response to the emission signal EM.

The 3-1 capacitor CQ3 has one end connected to the Q3 node and the other end connected to the INV node. The 3-2 capacitor CQ′3 has one end connected to the Q′3 node and the other end connected to the second electrode of the 3-8 transistor T38. Although not shown in the drawing, if necessary, a 3-3 capacitor CQB3 may be further included between the QB2 node and the input terminal of the second gate high voltage VEH.

The 3-1 capacitor CQ3 and the 3-2 capacitor CQ′3 may operate as the bootstrap capacitors. In addition, the 3-1 capacitor CQ3 may be designed to have a larger capacity than the 3-2 capacitor CQ′3. In other words, the 3-1 capacitor CQ3 may have a larger area than the 3-2 capacitor CQ′3.

The fourth shift register 24 may generate an inverted signal whose phase is inverted from that of the emission signal EM output from the third shift register 23 through the operation of the 3-1 transistor T31 and the 3-10 transistor T40 that are included in the first inverting unit 241.

The 3-11 transistor T41 has a gate electrode connected to the INV node, a first electrode connected to an OR node, and a second electrode connected to the input terminal of the second gate high voltage VEH. The 3-11 transistor T41 is turned on or off in response to the inverted signal that has the inverted phase of the emission signal EM generated in the first inverted unit 241.

The 3-12 transistor T42 has a gate electrode connected to an input terminal of the second scan signal S2 output from the second shift register 22, a first electrode connected to the OR node, and a second electrode connected to the input terminal of the second gate high voltage VEH. The 3-12 transistor T42 is turned on or off in response to the second scan signal S2.

The 3-13 transistor T43 has a gate electrode connected to the OR node, a first electrode connected to an output terminal IEMO of the inverting driver, and a second electrode connected to the input terminal of the second gate high voltage VEH. The 3-13 transistor T43 is turned on or off in response to a potential at the OR node.

A first resistor R1 has one end connected to the first electrode of the 3-11 transistor T41 and the other end connected to the input terminal of the second gate low voltage VEL. A second resistor R2 has one end connected to the input terminal of the second gate low voltage VEL and the other end connected to the output terminal IEMO of the inverting driver.

The fourth shift register 24 is configured to receive the inverted signal whose phase is inverted from that of the emission signal EM output from the third shift register 23 and the scan signal S2 output from the second shift register 22 through the operation of the 3-11 transistor T41 and the 3-12 transistor T42 that are included in the second inverting unit 242.

When at least one of the inverted signal whose phase is inverted from that of the emission signal EM and the scan signal S2 is at the turn-on level, the 3-11 transistor T41 or the 3-12 transistor T42 may be turned on, the second gate high voltage VEH may be applied to the gate electrode of the 3-13 transistor T43, and the 3-13 transistor T43 may be turned off to output the second gate low voltage VEL as the inverted emission signal IEM.

In addition, when both the inverted signal whose phase is inverted from that of the emission signal EM and the scan signal S2 are at the turn-off levels, the 3-11 transistor T41 or the 3-12 transistor T42 may be turn off, the 3-13 transistor T43 may be turned on, and the second gate high voltage VEH may be output as the inverted emission signal IEM.

The transistors included in the fourth shift register 24 are shown as being implemented as a single gate structure, but are not limited thereto, and the 3-1 transistor T31 to the 3-5 transistor T35 and the 3-8 transistor T38 to the 3-10 transistor T40 excluding the 3-6 transistor T36, the 3-7 transistor T37, and the 3-11 transistor T41 to the 3-13 transistor T43 can be implemented as the dual gate structure to prevent current leakage and improve driving reliability. In addition, some transistors may be formed in the dual gate structure, and other transistors may be formed in the single gate structure.

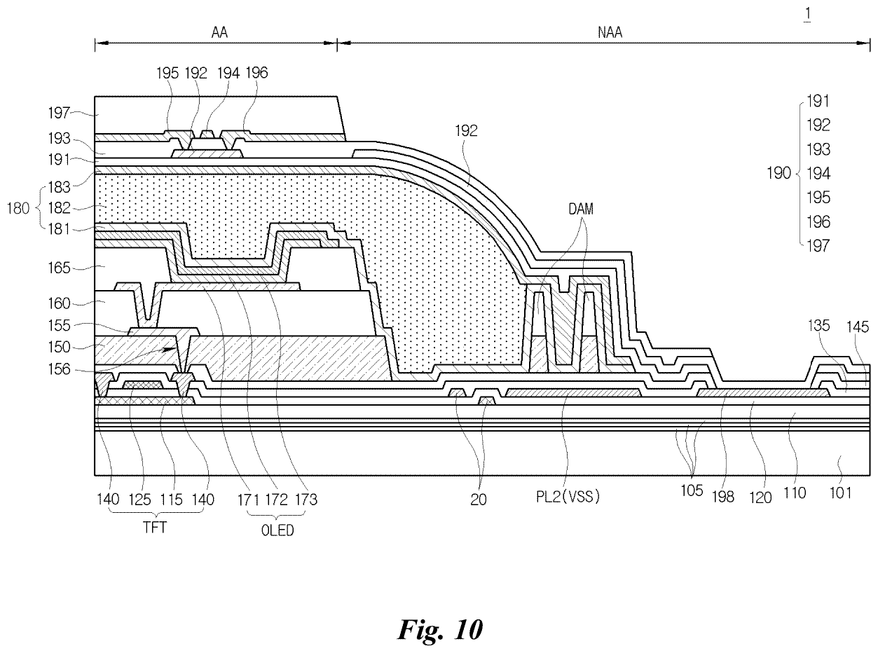

FIG. 10 is a cross-sectional view showing a stacked form of the display device according to one embodiment of the present specification.

Referring to FIG. 10, the thin film transistor TFT for driving the light emitting element LD may be disposed on the substrate 101 in the display area AA. In FIG. 10, for convenience of description, only the driving transistor DT (see FIG. 7) among various thin film transistors that may be included in the display device 1 is shown, but the thin film transistor TFT is not limited thereto. Hereinafter, although an example in which the thin film transistor TFT has a coplanar structure will be described, the thin film transistor TFT can be implemented in any of various other structures, such as a staggered structure.

The driving transistor DT may control the current supplied from the high potential driving voltage VDD to the light emitting element LD in response to the data signal supplied to a gate electrode 125. Therefore, the driving transistor DT may control the amount of light emitted from the light emitting element LD. In this case, a constant current may be supplied to the light emitting element LD until a data signal of the next frame is supplied by the voltage charged in the storage capacitor (e.g., the first capacitor C1 in FIG. 7), and thus the emitting state of the light emitting element LD may be maintained. The high potential driving voltage line PL1 (see FIG. 1) that supplies the high potential driving voltage VDD may be formed parallel to the data line DL (see FIG. 1).

The thin film transistor TFT may include a semiconductor layer 115 disposed on a first insulating layer 110, a gate electrode 125 overlapping the semiconductor layer 115 with the second insulating layer 120 interposed therebetween, and source and drain electrodes 140 formed on a third insulating layer 135 and in contact with the semiconductor layer 115.

The semiconductor layer 115 may be an area in which a channel is formed when the thin film transistor TFT is driven. The semiconductor layer 115 may be formed of an oxide semiconductor, amorphous silicon (a-Si), polycrystalline silicon (poly-Si), or various organic semiconductors, such as pentacene, but is not limited thereto.

The semiconductor layer 115 may be formed on the first insulating layer 110. The semiconductor layer 115 may include a channel area, a source area, and a drain area. The channel area may overlap the gate electrode 125 with the first insulating layer 110 interposed therebetween to form the channel area between the source and drain electrodes 140. The source area is electrically connected to the source electrode 140 through a contact hole passing through the second insulating layer 120 and the third insulating layer 135. The drain area is electrically connected to the drain electrode 140 through a contact hole passing through the second insulating layer 120 and the third insulating layer 135.

A buffer layer 105 and the first insulating layer 110 may be disposed between the semiconductor layer 115 and the substrate 101. The buffer layer 105 may delay the diffusion of moisture and/or oxygen that has permeated the substrate 101. The first insulating layer 110 can protect the semiconductor layer 115 and block various types of defects introduced from the substrate 101.

An uppermost layer of the buffer layer 105 in contact with the first insulating layer 110 may be made of a material with different etching characteristics from the remaining layers of the buffer layer 105, the first insulating layer 110, the second insulating layer 120, and the third insulating layer 135. The uppermost layer of the buffer layer 105 in contact with the first insulating layer 110 may be made of any one of silicon nitride (SiNₓ) and silicon oxide (SiOₓ). The remaining layers of the buffer layer 105, the first insulating layer 110, the second insulating layer 120, and the third insulating layer 135 may be made of the other of silicon nitride (SiNₓ) and silicon oxide (SiOₓ). For example, the uppermost layer of the buffer layer 105 in contact with the first insulating layer 110 may be made of silicon nitride (SiNₓ), and the remaining layers of the buffer layer 105, the first insulating layer 110, the second insulating layer 120, and the third insulating layer 135 may be made of silicon oxide (SiOₓ), but are not limited thereto.

The gate electrode 125 may be formed on the second insulating layer 120 and may overlap the channel area of the semiconductor layer 115 with the second insulating layer 120 interposed therebetween. The gate electrode 125 may be made of a first conductive material, which is a single layer or a multi-layer made of any one of magnesium (Mg), molybdenum (Mo), aluminum (Al), chromium (Cr), gold (Au), titanium (Ti), nickel (Ni), neodymium (Nd), and copper (Cu) or an alloy thereof, but is not limited thereto.

The source electrode 140 may be connected to the source area of the semiconductor layer 115 exposed through the contact hole passing through the second insulating layer 120 and the third insulating layer 135. The drain electrode 140 may face the source electrode 140 and may be connected to the drain area of the semiconductor layer 115 through the contact hole passing through the second insulating layer 120 and the third insulating layer 135. The source and drain electrodes 140 may be made of a second conductive material, which is a single layer or a multi-layer made of any one of molybdenum (Mo), aluminum (Al), chromium (Cr), gold (Au), titanium (Ti), nickel (Ni), neodymium (Nd), and copper (Cu) or two or more alloys, but is not limited thereto.

A connection electrode 155 may be disposed between a first intermediate layer 150 and a second intermediate layer 160. The connection electrode 155 may be exposed through a connection electrode contact hole 156 passing through a protective film 145 and the first intermediate layer 150 and connected to the drain electrode 140. The connection electrode 155 may be made of a material with low specific resistance that is the same as or similar to that of the drain electrode 140, but is not limited thereto.

The light emitting element LD including a light emitting layer 172 may be disposed on the second intermediate layer 160 and a bank layer 165. The light emitting element LD may include an anode 171, at least one light emitting layer 172 formed on the anode 171, and a cathode 173 formed on the light emitting layer 172.

The anode 171 may be disposed on the first intermediate layer 150 through the contact hole passing through the second intermediate layer 160 and electrically connected to the connection electrode 155 exposed upward from the second intermediate layer 160.

The anode 171 of each pixel is formed to be exposed by the bank layer 165. The bank layer 165 may be made of an opaque material (e.g., black) to prevent light interference between adjacent pixels. In this case, the bank layer 165 may include a light blocking material made of at least any one of color pigment, organic black, and carbon, but is not limited thereto.

At least one light emitting layer 172 may be formed on the anode 171 in an emission area provided by the bank layer 165. At least one light emitting layer 172 may include a hole transport layer, a hole injection layer, a hole blocking layer, the emission layer 172, an electron injection layer, an electron blocking layer, an electron transport layer, and the like on the anode 171 and may be formed to be stacked sequentially or reversely in an emission direction. In addition, the light emitting layer 172 may include first and second emission stacks opposite to each other with a charge generation layer interposed therebetween. In this case, since the light emitting layer 172 of any one of the first and second emission stacks may generate blue light, and the light emitting layer 172 of the other of the first and second emission stacks may generate yellow-green light, white light may be generated through the first and second emission stacks. White light emitted from the emission stacks is incident on color filters positioned above or under the light emitting layer 172, color images can be implemented. As another example, the color images can be implemented by emitting color light corresponding to each pixel from each light emitting layer 172 without a separate color filter. For example, the light emitting layer 172 of a red pixel may emit red light, the light emitting layer 172 of a green pixel may emit green light, and the light emitting layer 172 of a blue pixel may emit blue light.

The cathode 173 may be formed opposite to the anode 171 with the light emitting layer 172 interposed therebetween and may receive the high potential driving voltage VDD.

An encapsulation layer 180 may block the introduction of external moisture or oxygen into the light emitting element LD vulnerable to external moisture or oxygen. To this end, the encapsulation layer 180 may include at least one inorganic encapsulation layer and at least one layer organic encapsulation layer, but is not limited thereto. Hereinafter, a structure of the encapsulation layer 180 in which a first encapsulation layer 181, a second encapsulation layer 182, and a third encapsulation layer 183 are sequentially stacked will be described as an example.

The first encapsulation layer 181 is formed on the substrate 101 on which the cathode 173 is formed. The third encapsulation layer 183 may be formed on the substrate 101 on which the second encapsulation layer 182 is formed and formed to surround an upper surface, a lower surface, and side surfaces of the second encapsulation layer 182 together with the first encapsulation layer 181. The first encapsulation layer 181 and the third encapsulation layer 183 can minimize or prevent external moisture or oxygen from flowing into the light emitting element LD. The first encapsulation layer 181 and the third encapsulation layer 183 may be made of an inorganic insulating material capable of low-temperature deposition, such as silicon nitride (SiNₓ), silicon oxide (SiOₓ), silicon oxynitride (SiON), or aluminum oxide (Al₂O₃). Since the first encapsulation layer 181 and the third encapsulation layer 183 are deposited in a low temperature atmosphere, it is possible to prevent damage to the light emitting element LD vulnerable to a high temperature atmosphere in a deposition process of the first encapsulation layer 181 and the third encapsulation layer 183.

The second encapsulation layer 182 may serve as a buffer for mitigating stress between the layers due to the bending of the display device 1 and planarize step differences between the layers. The second encapsulation layer 182 may be formed on the substrate 101 on which the first encapsulation layer 181 is formed and made of a non-photosensitive organic insulating material, such as acrylic resin, epoxy resin, phenolic resin, polyamide resin, polyimide resin, and polyethylene or silicon oxycarbon (SiOC), or a photosensitive organic insulating material, such as photoacrylic, but is not limited thereto. When the second encapsulation layer 182 is formed through an inkjet method, a dam DAM may be disposed to prevent the second encapsulation layer 182 in a liquid form from spreading to an edge of the substrate 101. The dam DAM may be disposed closer to the edge of the substrate 101 than the second encapsulation layer 182. The dam DAM can prevent the second encapsulation layer 182 from spreading to a pad area in which a conductive pad disposed at an outermost side of the substrate 101 is disposed.

The dam DAM may be designed to prevent the spreading of the second encapsulation layer 182, but when the second encapsulation layer 182 is formed to exceed a height of the dam DAM in the process, the second encapsulation layer 182, which is an organic layer, may be exposed to the outside, and thus moisture or the like may easily flow into the light emitting element. Therefore, to prevent the same, at least 10 dams DAM may be formed to overlap each other.

The dam DAM may be disposed on the protective film 145 in the non-display area NAA. In addition, the dam DAM may be formed simultaneously with the first intermediate layer 150 and the second intermediate layer 160. When the first intermediate layer 150 is formed, a lower layer of the dam DAM may be formed together, and when the second intermediate layer 160 is formed, an upper layer of the dam DAM may be formed together, and thus the dam DAM may be formed by being stacked in a double structure. Therefore, the dam DAM may be made of the same material as the first intermediate layer 150 and the second intermediate layer 160, but is not limited thereto.

The dam DAM may be formed to overlap the low potential driving voltage line PL2. For example, the low potential driving voltage line PL2 may be formed on a lower layer of an area in which the dam DAM is positioned in the non-display area NAA.

The low potential driving voltage line PL2 and the gate driver 20 formed in the form of the GIP may be formed in the form of surrounding an outer side of the display panel, and the low potential driving voltage line PL2 may be positioned outside the gate driver 20. In addition, the low potential driving voltage line PL2 may be connected to the anode 171 to apply a common voltage. The gate driver 20 is briefly shown in plan and cross-sectional views, but may be configured using a thin film transistor TFT with the same structure as the thin film transistors TFT in the display area AA.

The low potential driving voltage line PL2 is disposed outside the gate driver 20. The low potential driving voltage line PL2 is disposed outside the gate driver 20 and surrounds the display area AA. The low potential driving voltage line PL2 may be made of the same material as the source and drain electrodes 140 of the thin film transistor TFT, but is not limited thereto. For example, the low potential driving voltage line PL2 may be made of the same material as the gate electrode 125.

In addition, the low potential driving voltage line PL2 may be electrically connected to the anode 171. The low potential driving voltage line PL2 may supply the low potential driving voltage VSS to the plurality of pixels in the display area AA.

A touch layer 190 may be disposed on the encapsulation layer 180. In the touch layer, a touch buffer film 191 may be positioned between a touch sensor metal including touch electrode connection lines 192 and 194 and touch electrodes 195 and 196 and the cathode 173 of the light emitting element LD.

The touch buffer film 191 can block a chemical solution (developer, etchant, or the like) used in a process of manufacturing the touch sensor metal disposed on the touch buffer film 191 or external moisture or the like from flowing into the emission layer 172 including the organic material. Therefore, the touch buffer film 191 can prevent damage to the light emitting layer 172 vulnerable to a chemical solution or moisture.

The touch buffer layer 191 may be formed at a selected (in some cases, predetermined) temperature (e.g., a low temperature of 100° C. or lower) to prevent damage to the emission layer 172 containing an organic material vulnerable to high temperatures and made of an organic insulating material with a low dielectric constant of 1 to 3. For example, the touch buffer film 191 may be made of an acrylic-based, epoxy-based, or siloxan-based material. The touch buffer film 191 made of an organic insulating material and having planarization performance can prevent damage to the encapsulation layer 180 due to the bending of an organic light emitting diode display device and cracking of the touch sensor metal formed on the touch buffer film 191.

According to the mutual-capacitance-based touch sensor structure, the touch electrodes 195 and 196 may be disposed on the touch buffer film 191, and the touch electrodes 195 and 196 may be disposed to cross each other.

The touch electrode connection lines 192 and 194 may electrically connect the touch electrodes 195 and 196. The touch electrode connection lines 192 and 194 and the touch electrodes 195 and 196 may be positioned on different layers with the touch insulating film 193 interposed therebetween.

The touch electrode connection lines 192 and 194 may be disposed to overlap the bank layer 165, thereby preventing a reduction in an aperture ratio.

Meanwhile, a portion of the touch electrode connection line 192 may be electrically connected to a touch driving circuit (not shown) through a touch pad 198 after passing an upper portion and a side surface of the encapsulation layer 180 and an upper portion and a side surface of the dam DAM.

The portion of the touch electrode connection line 192 may transmit the touch driving signal to the touch electrodes 195 and 196 after receiving a touch driving signal from the touch driving circuit and transmit touch sensing signals from the touch electrodes 195 and 196 to the touch driving circuit.

A touch protective film 197 may be disposed on the touch electrodes 195 and 196. In the drawing, the touch protective film 197 is shown as being disposed only on the touch electrodes 195 and 196, but is not limited thereto, and the touch protective film 197 may extend to an area before or after the dam DAM and may be disposed on the touch electrode connection line 192.

In addition, a color filter (not shown) may be further disposed on the encapsulation layer 180, and the color filter may be positioned on the touch layer or positioned between the encapsulation layer 180 and the touch layer 190.

The display device according to the embodiment of the present specification may be described as follows.

The display device according to the embodiment of the present specification may include a display panel including a display area in which pixel circuits are disposed and a non-display area near the display area, and a gate driver for applying a scan signal, an emission signal, and an inverted emission signal to the pixel circuits, in which the gate driver may include at least one scan driver for outputting the scan signal, a light emitting driver for outputting the emission signal, and inverting drivers of which at least some output the inverted emission signal of which phase is inverted from that of the emission signal using the scan signal output from the at least one scan driver and the emission signal output from the light emitting driver.

In the display device according to the embodiment of the present specification, the pixel circuit may include a light emitting element, a driving transistor receiving a high potential driving voltage through a first electrode, having a second electrode connected to the light emitting element, and controlling the amount of driving current supplied to the light emitting element in response to a voltage of a gate electrode, a first switching transistor transmitting a data voltage to the gate electrode of the driving transistor in response to a first scan signal, a light emitting transistor forming a current path between the driving transistor and the light emitting element in response to the emission signal, and an initialization transistor transmitting an initialization voltage to an anode of the light emitting element in response to an inverted emission signal.

In the display device according to the embodiment of the present specification, the gate driver may be disposed at each of left and right sides of the display area in the non-display area and configured symmetrically.

In the display device according to the embodiment of the present specification, the scan driver may include a first scan driver for outputting the first scan signal and a second scan driver for outputting a second scan signal, and the second scan signal may be applied to the inverting driver.

In the display device according to the embodiment of the present specification, the inverting driver may be disposed closer to the display area than the light emitting driver and the at least one scan driver are.

In the display device according to the embodiment of the present specification, the inverting driver may include a first inverting unit for generating an inverted signal whose phase is inverted from that of the emission signal and a second inverting unit for outputting the inverted emission signal according to the inverted signal or the scan signal.

In the display device according to the embodiment of the present specification, the first inverted unit may operate based on the emission signal, the first emission clock signal, and the second emission clock signal, include a Q node, a QB node, and a Q′ node that controls the QB node, and output the inverted signal in response to a potential at the Q node or the QB node.

In the display device according to the embodiment of the present specification, the first inverting unit may include a first transistor having a gate electrode connected to an input terminal of a first emission clock signal, a first electrode connected to an input terminal of the emission signal, and a second electrode connected to the QB node, a second transistor having a gate electrode connected to the input terminal of the first emission clock signal and a first electrode connected to the QB node, a third transistor having a first electrode connected to the second transistor and a second electrode connected to an input terminal of a gate high voltage, a fourth transistor having a gate electrode connected to an input terminal of a second emission clock signal, a first electrode connected to an input terminal of a gate low voltage, and a second electrode connected to the gate electrode of the third transistor, a fifth transistor having a gate electrode connected to the QB node, a first electrode connected to the Q node, and a second electrode connected to an input terminal of the gate high voltage, a sixth transistor having a gate electrode connected to the Q node, a first electrode connected the input terminal of the gate low voltage, and a second electrode connected to an INV node that applies an inverted signal to the second inverting unit, a seventh transistor having a gate electrode connected to the QB node, a first electrode connected to the INV node that applies the inverted signal to a second inverting unit, and a second electrode connected to an input terminal of a gate high voltage, an eighth transistor having a gate electrode connected the Q′ node and a first electrode connected to the input terminal of the first emission clock signal, a ninth transistor having a gate electrode connected to the input terminal of the first emission clock signal, a first electrode connected to the second electrode of the eighth transistor, and a second electrode connected to the Q node, and a tenth transistor having a gate electrode connected to the input terminal of the emission signal, a first electrode connected to an input terminal of a second emission clock signal, and a second electrode connected to the Q′ node.

In the display device according to the embodiment of the present specification, the first inverting unit may further include a first capacitor having one end connected to the Q node and the other end connected to the INV node, and a second capacitor having one end connected to the QB node Q′ node and the other end connected to the second electrode of the eighth transistor.

In the display device according to the embodiment of the present specification, the first capacitor or the second capacitor may be a bootstrap capacitor.

In the display device according to the embodiment of the present specification, the first capacitor may have a larger capacity than the second capacitor.

In the display device according to the embodiment of the present specification, a second inversion unit may include an eleventh transistor turned on according to the inverted signal applied to the INV node, a twelfth transistor turned on by receiving a scan signal output from the at least one scan driver, and a thirteenth transistor turned on while the eleventh transistor or the twelfth transistor is turned on.

In the display device according to the embodiment of the present specification, the second inverting unit may include an eleventh transistor having a gate electrode connected to the INV node, a first electrode connected to an OR node, and a second electrode connected to the input terminal of the gate high voltage, a twelfth transistor having a gate electrode connected to the input terminal of the scan signal, a first electrode connected to the OR node, and a second electrode connected to the input terminal of the gate high voltage, and a thirteenth transistor having a gate electrode connected to the OR node, a first electrode connected to an output terminal of the inverting driver, and a second electrode connected to the input terminal of the gate high voltage.

In the display device according to the embodiment of the present specification, the second inverting unit may output the gate low voltage as the inverted emission signal when at least one of the inverted signal and the scan signal are at turn-on levels.

In the display device according to the embodiment of the present specification, the second inverting unit may output the gate high voltage as the inverted emission signal when both the inverted signal and the scan signal are at turn-off levels.

The display device according to the embodiment of the present specification may further include a coupling capacitor connected between an inverted emission line to which the inverted emission signal is applied and the gate electrode of the driving transistor.

In the display device according to the embodiment of the present specification, the coupling capacitor may transmit a coupling voltage corresponding to the inverted emission signal to the gate electrode of the driving transistor.

In the display device according to the embodiment of the present specification, the pixel circuit may further include a storage capacitor connected to a first switching transistor through a first node and the gate electrode of the driving transistor through a second node and may further include a coupling capacitor connected between the input terminal of the inverted emission signal and the first node.

In the display device according to the embodiment of the present specification, the storage capacitor may have a larger capacity than the coupling capacitor.

In the display device according to the embodiment of the present specification, the pixel circuit may be driven at a low frequency in which 1 frame includes an anode initialization period and an emission period in a variable refresh rate mode, the gate driver may apply the emission signal at the turn-off level to the pixel circuit during the anode initialization period and apply the emission signal at the turn-on level to the pixel circuit during the emission period, and the initialization transistor may apply an initialization voltage to an anode of a light emitting element in response to the inverted emission signal during the anode initialization period.

In the display device according to the embodiment of the present specification, the pixel circuit may be driven in the case in which 1 frame includes at least one refresh period and at least one skip period, the refresh period may include a programming period PP and an emission period, and the skip period may include an anode initialization period and an emission period, and the initialization transistor may apply the initialization voltage to the anode of the light emitting element in response to the inverted emission signal during the anode initialization period.

In the display device according to the embodiment of the present specification, a length of the anode initialization period may be equal to a length of the programming period.

In the display device according to the embodiment of the present specification, the voltage at the gate electrode of the driving transistor may be decreased by a selected (in some cases, predetermined) level due to a coupling voltage corresponding to the inverted emission signal in the coupling capacitor.

The display device according to the embodiments of the present specification can prevent the charging delay of the light emitting element upon the low-frequency driving in the variable refresh rate mode and adjust the characteristics and on-bias stress of the driving transistor.

The display device according to the embodiments of the present specification can minimize the flicker phenomenon in the variable refresh rate mode and uniformly control the overall brightness.

The effects according to the present specification are not limited to the above-described contents, and other effects that are not mentioned will be able to be clearly understood by those skilled in the art to which the present specification pertains from the following description.

The above description and the accompanying drawings are merely illustrative of the technical spirit of the present specification, and those skilled in the art to which the present specification pertains can perform various changes or modifications, such as coupling, separation, substitution, and change of components, without departing from the essential characteristics of the present specification. Therefore, the embodiments disclosed in the present specification are not intended to limit the technical spirit of the present specification, but is intended to describe the same, and the scope of the technical spirit of the present specification is not limited by these embodiments. The scope of the present specification should be construed according to the appended claims, and all technical spirits within the equivalent range should be construed as being included in the scope of the present specification.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display device comprising:
a display panel including a display area in which pixel circuits are disposed and a non-display area near the display area; and
a gate driver configured to apply a scan signal, an emission signal, and an inverted emission signal to the pixel circuit,
wherein the gate driver includes:
at least one scan driver configured to output the scan signal;
a light emitting driver configured to output the emission signal; and
inverting drivers of which at least some output the inverted emission signal of which phase is inverted from that of the emission signal based on the scan signal output from the at least one scan driver and the emission signal output from the light emitting driver.

2. The display device of claim 1, wherein the pixel circuit includes:
a light emitting element having an anode;
a driving transistor receiving a high potential driving voltage through a first electrode, having a second electrode connected to the light emitting element, and controlling an amount of driving current supplied to the light emitting element in response to a voltage of a gate electrode;
a first switching transistor transmitting a data voltage to the gate electrode of the driving transistor in response to a first scan signal;
a light emitting transistor forming a current path between the driving transistor and the light emitting element in response to the emission signal; and
an initialization transistor transmitting an initialization voltage to the anode of the light emitting element in response to the inverted emission signal.

3. The display device of claim 1, wherein the gate driver is disposed at each of left and right sides of the display area in the non-display area and configured symmetrically.

4. The display device of claim 2, wherein the scan driver includes:
a first scan driver configured to output the first scan signal; and
a second scan driver configured to output a second scan signal, and
wherein the second scan signal is applied to the inverting driver.

5. The display device of claim 1, wherein the inverting driver is disposed closer to the display area than the light emitting driver and the at least one scan driver are.

6. The display device of claim 1, wherein the inverting driver includes:
a first inverting circuit configured to generate an inverted signal whose phase is inverted from that of the emission signal; and
a second inverting circuit configured to output the inverted emission signal according to the inverted signal or the scan signal.

7. The display device of claim 6, wherein the first inverting circuit operates based on the emission signal, a first emission clock signal, and a second emission clock signal and includes a Q node, a QB node, and a Q′ node controlling the QB node, and
outputs the inverted signal in response to a potential at the Q node or the QB node.

8. The display device of claim 7, wherein the first inverting circuit includes:
a first transistor having a gate electrode connected to an input terminal of the first emission clock signal, a first electrode connected to an input terminal of the emission signal, and a second electrode connected to the QB node;
a second transistor having a gate electrode connected to the input terminal of the first emission clock signal and a first electrode connected to the QB node;
a third transistor having a first electrode connected to a second electrode of the second transistor and a second electrode connected to an input terminal of a gate high voltage;
a fourth transistor having a gate electrode connected to an input terminal of the second emission clock signal, a first electrode connected to an input terminal of a gate low voltage, and a second electrode connected to a gate electrode of the third transistor;
a fifth transistor having a gate electrode connected to the QB node, a first electrode connected to the Q node, and a second electrode connected to an input terminal of the gate high voltage;
a sixth transistor having a gate electrode connected to the Q node, a first electrode connected to the input terminal of the gate low voltage, and a second electrode connected to an INV node that applies the inverted signal to the second inverting circuit;
a seventh transistor having a gate electrode connected to the QB node, a first electrode connected to the INV node that applies the inverted signal to the second inverting circuit, and a second electrode connected to the input terminal of the gate high voltage;
an eighth transistor having a gate electrode connected to the Q′ node and a first electrode connected to the input terminal of the first emission clock signal;
a ninth transistor having a gate electrode connected to the input terminal of the first emission clock signal, a first electrode connected to a second electrode of the eighth transistor, and a second electrode connected to the Q node; and
a tenth transistor having a gate electrode connected to the input terminal of the emission signal, a first electrode connected to the input terminal of the second emission clock signal, and a second electrode connected to the Q′ node.

9. The display device of claim 8, wherein the first inverting circuit further includes:
a first capacitor having one end connected to the Q node and the other end connected to the INV node; and
a second capacitor having one end connected to the Q′ node and the other end connected to a second electrode of the eighth transistor.

10. The display device of claim 9, wherein either the first capacitor or the second capacitor is a bootstrap capacitor.

11. The display device of claim 9, wherein the first capacitor has a larger capacity than the second capacitor.

12. The display device of claim 9, wherein the second inverting circuit includes:
an eleventh transistor turned on according to the inverted signal applied to the INV node;
a twelfth transistor turned on by receiving the scan signal output from the at least one scan driver; and
a thirteenth transistor turned on while the eleventh transistor or the twelfth transistor is turned on.

13. The display device of claim 9, wherein the second inverting circuit includes:
an eleventh transistor having a gate electrode connected to the INV node, a first electrode connected to a OR node, and a second electrode connected to the input terminal of the gate high voltage;
a twelfth transistor having a gate electrode connected to an input terminal of the scan signal, a first electrode connected to the OR node, and a second electrode connected to the input terminal of the gate high voltage; and
a thirteenth transistor having a gate electrode connected to the OR node, a first electrode connected to an output terminal of the inverting driver, and a second electrode connected to an input terminal of the gate high voltage.

14. The display device of claim 8, wherein the second inverting circuit outputs the gate low voltage as the inverted emission signal when at least one of the inverted signal and the scan signal is at a turn-on level.

15. The display device of claim 6, wherein the second inverting circuit outputs a gate high voltage as the inverted emission signal when both the inverted signal and the scan signal are at turn-off levels.

16. The display device of claim 2, wherein the pixel circuit further includes a coupling capacitor connected between an inverted emission line to which the inverted emission signal is applied and the gate electrode of the driving transistor.

17. The display device of claim 16, wherein the coupling capacitor transmits a coupling voltage corresponding to the inverted emission signal to the gate electrode of the driving transistor.

18. The display device of claim 2, wherein the pixel circuit further includes:
a storage capacitor connected to the first switching transistor through a first node and connected to the gate electrode of the driving transistor through a second node; and
a coupling capacitor connected between the input terminal of the inverted emission signal and the first node.

19. The display device of claim 18, wherein the storage capacitor has a larger capacity than the coupling capacitor.

20. The display device of claim 2, wherein the pixel circuit is driven at a low frequency in which 1 frame includes an anode initialization period and an emission period in a variable refresh rate mode,
wherein the gate driver applies an emission signal at a turn-off level to the pixel circuit during the anode initialization period and applies the emission signal at a turn-on level to the pixel circuit during the emission period, and
wherein the initialization transistor applies the initialization voltage to the anode of the light emitting element in response to the inverted emission signal during the anode initialization period.

21. The display device of claim 2, wherein the pixel circuit is driven in the case in which 1 frame includes at least one refresh period and at least one skip period,
wherein the refresh period includes a programming period PP and an emission period, and the skip period includes an anode initialization period and an emission period, and
wherein the initialization transistor applies the initialization voltage to the anode of the light emitting element in response to the inverted emission signal during the anode initialization period.

22. The display device of claim 21, wherein a length of the anode initialization period is equal to a length of the programming period.

23. The display device of claim 16, wherein the voltage at the gate electrode of the driving transistor is decreased by a selected level due to a coupling voltage corresponding to the inverted emission signal in the coupling capacitor.
